(19) United States
(12) Patent Application Publication
(10) Pub. No.: US 2014/0347379 A1
(43) Pub. Date: Nov. 27, 2014

(54) TECHNIQUE FOR REDUCING BANDWIDTH CONSUMPTION DURING FRAME ROTATION

(71) Applicant: NVIDIA CORPORATION, Santa Clara, CA (US)

(72) Inventors: Richard Gary John BAVERSTOCK, Gilroy, CA (US); Han CHOU, Santa Clara, CA (US)

(73) Assignee: NVIDIA CORPORATION, Santa Clara, CA (US)

(21) Appl. No.: 13/902,571

(22) Filed: May 24, 2013

(51) Int. Cl. G06T 1/60; G06T 3/60

(52) U.S. Cl. CPC G06T 1/60; G06T 3/606
USPC 345/537

(57) ABSTRACT

A decode engine is configured to perform a rotation operation with a macroblock in conjunction with performing a deblocking operation that involves the macroblock. The decode engine decodes the macroblock and performs the deblocking operation to generate a deblocked macroblock, then rotates the deblocked macroblock and writes the rotated, deblocked macroblock to memory. With this approach, multiple, redundant reads of the macroblock, as required with conventional rotation techniques, may be avoided.

### BACKGROUND OF THE INVENTION

1. Field of the Invention

Embodiments of the invention generally relate to video processing and, more specifically, to a technique for reducing bandwidth consumption during frame rotation.

2. Description of the Related Art

A modern mobile device, such as a cell phone or tablet computer, typically includes a video camera capable of capturing frames of video data. Video processing circuitry within the mobile device may process the frames of video data and then store those frames in memory included within the mobile device. The frames of video data may then be displayed to a user of the mobile device at a later time.

The video camera within the mobile device typically captures the frames of video data with a particular orientation corresponding to the orientation of the mobile device itself during capture. The frames of video data could also originate from a different source, as well, such as a digital video disc (DVD), BluRay, Disc, and so forth. The orientation could be, e.g., a portrait orientation or a landscape orientation. The frames of video data may be stored in memory according to that same orientation. However, the user of the mobile device may wish to view those frames with a different orientation. Accordingly, the video processing circuitry within the mobile device may rotate each frame of the video data to assume the desired orientation.

One problem with the above approach is that rotating the frames of video data requires memory bandwidth. In particular, each frame of video data must be read from memory, rotated, and then each rotated frame must be written back to memory. With this approach, an amount of memory bandwidth may be consumed that is equal to twice the size of each frame, for each frame that must be rotated. In addition, rotating the frames of video data prior to viewing may incur a latency penalty that could disrupt the user experience associated with viewing those frames. For example, if the user decides to view the frames of video data according to a different orientation than those frames were originally captured, then the user is required to wait for the rotation operation to complete before the rotated frames of video data may be viewed. With relatively long sequences of frames, the user could be required to wait for a significant amount of time.

As the foregoing illustrates, what is needed in the art is an improved technique for rotating frames of video data.

### SUMMARY OF THE INVENTION

One embodiment of the present invention sets forth a computer-implemented method for processing frames of video data. The method includes retrieving from a local buffer a first portion of video data that is associated with a first frame included in a plurality of frames of video data, copying to the local buffer a second portion of video data that is also associated with the first frame, where the second portion of video data resides adjacent to the first portion of video data within the first frame, and performing a deblocking operation based on the first portion of video data and the second portion of video data to generate a deblocked first portion of video data and a deblocked second portion of video data. The method also includes performing a rotation operation on the deblocked second portion of video data to generate a rotated and deblocked second portion of video data, and writing the rotated and deblocked second portion of video data to a memory unit.

One advantage of the disclosed technique is that the amount of data read from memory in order to rotate a frame of video data is reduced, thereby decreasing the amount of memory bandwidth and power consumed when rotating the frame of video data.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a computing device configured to implement one or more aspects of the present invention;

FIG. 2 is a conceptual diagram that illustrates a frame of video data and a rotated frame of video data generated by the decode engine of FIG. 1, according to one embodiment of the present invention; and

FIG. 3 illustrates a flow diagram of method steps for rotating a frame of video data to generate a rotated frame of video data, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details.

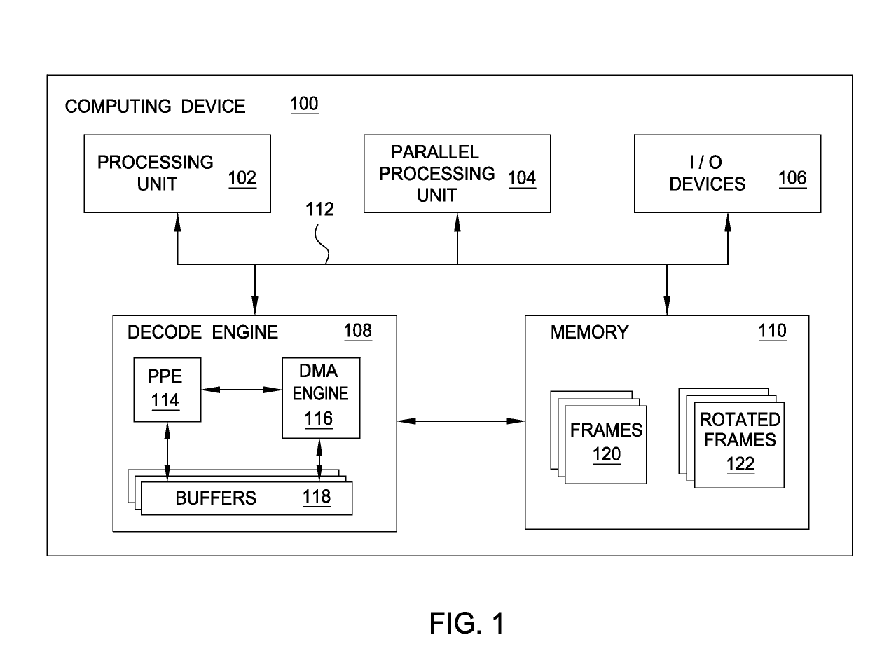

FIG. 1 is a block diagram of a computing device 100 configured to implement one or more aspects of the present invention. In one embodiment, computing device 100 may be included within a mobile device, such as a cell phone, tablet computer, digital camera, and so forth, and may represent a system-on-a-chip (SoC) configured to manage the operation of that mobile device. As shown, computing device 100 includes, without limitation, a processing unit 102, a parallel processing unit (PPU) 104, input/output (I/O) devices 106, a decode engine 108, and a memory 110 coupled together via an interconnect 112.

Processing unit 102 may be central processing unit (CPU), a microprocessor, an application specific integrated circuit (ASIC), or any other technically feasible hardware unit that is capable of processing data and executing program instructions. Processing unit 102 is configured to coordinate the operation of other hardware units within computing device 100, including, e.g. PPU 104.

PPU 104 may be a graphics processing unit (GPU) or any other technically feasible hardware unit configured to support the parallel execution of program instructions. PPU 104 is generally configured to operate in conjunction with processing unit 102.

I/O devices 106 may include devices capable of receiving input, such as a video camera, a keyboard, a mouse, a microphone, and so forth, as well as devices capable of providing output, such as a display device, a speaker, and so forth. Additionally, I/O devices 106 may include devices capable of both receiving input and providing output, such as a touch screen, a universal serial bus (USB) port, and so forth. A video camera within I/O devices 106 is configured to capture frames of video data and to store those frames within memory 110 as frames 120 of video data.

Memory unit 110 may include a random access memory (RAM) module, a flash memory unit, disk drive storage device, or any other type of memory unit or combination thereof. Memory 110 includes frames 120 of video data and rotated frames 122 of video data. Frames 120 and rotated frames 122 may be processed, updated, or generated by decode engine 108.

Decode engine 108 is a hardware unit configured to perform various operations with frames 120 and rotated frames 122. As is shown, decode engine 108 includes a post-processing engine (PPE) 114, a direct memory access unit (DMA) engine 116, and buffers 118. PPE 114, DMA engine 116, and buffers 118 are configured to interoperate in order to perform various aspects of the present invention.

In particular, PPE 114 is configured to perform a deblocking operation that involves different portions of a frame 120. PPE 114 may receive a first portion of a frame 120 from an upstream unit in a processing pipeline implemented by decode engine 108 or from buffer 118. PPE 114 may then cause DMA 116 to retrieve a second portion of the frame 120 from memory 110. The first and second portions of the frame may reside adjacent to one another in the frame 120. In one embodiment, the first and second portions of the frame are macroblocks included in the frame 120, and the second portion of the frame 120 represents the above-neighbor of the first portion of the frame 120.

DMA 116 is configured to buffer the second portion of the frame 120 in buffers 118. PPE 114 may then perform a deblocking operation with the first and second portions of the frame 120, and then write deblocked portions of the frame 120 to buffers 118. DMA engine 116 may then retrieve the deblocked portions of the frame 120 from buffers 118 and update the frame 120 to include the deblocked portions. DMA engine 116 may also perform a rotation operation with part of the deblocked portions and then write a rotated, deblocked portion to rotated frames 122. By performing the deblocking operation in conjunction with performing the rotation operation, decode engine 108 may avoid reading the same portions of frames 120 on two separate occasions when executing those two different operations, thereby conserving memory bandwidth and expediting the generation of rotated frames 122.

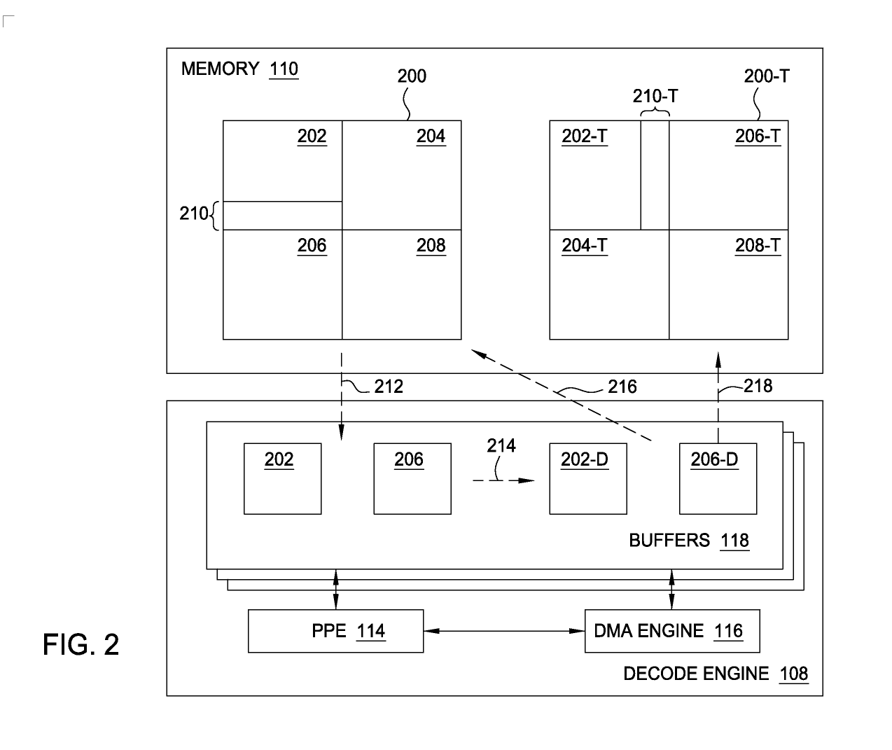

The different elements within decode engine 108 may perform the aforementioned process for each frame included within frames 120, thereby generating each rotated frame 122. The general approach described thus far is illustrated in greater detail by way of example in conjunction with FIG. 2.

FIG. 2 is a conceptual diagram that illustrates a frame of video 200 and a rotated frame 200-T of video generated by decode engine 108 of FIG. 1, according to one embodiment of the present invention. As shown, frames 200 and 200-T reside within memory 110. Frame 200 includes macroblocks 202, 204, 206, and 208. Macroblock 202 within frame 200 includes a strip 210 of pixels. Frame 200-T includes macroblocks 202-T, 206-T, 204-T, and 208-T. Macroblock 202-T within rotated frame 200-T includes strip 210-T of pixels.

Frame 200-T represents a rotated version of frame 200. Decode engine 108 may generate frame 200-T by performing a transposition operation with frame 200. In performing that rotation operation, decode engine 108 may transpose macroblocks 202, 204, 206, and 208 to generate macroblocks 202-T, 204-T, 206-T, and 208-T, respectively. Additionally, decide engine 108 may transpose the positions of certain macroblocks, thereby transposing frame 200 as a whole. In the example discussed herein, the positions of macroblocks 204-T and 206-T have been transposed by decode engine 108 relative to the positions of the original macroblocks 204 and 206, as is shown. Persons skilled in the art will recognize that decode engine 108 may implement a wide variety of operations in order to rotate, transpose, flip, or otherwise modify the orientation of frame 200 and/or the organization of macroblocks within that frame.

Decode engine 108 is also configured to perform a deblocking operation with specific macroblocks within frame 200 prior to performing the rotation operation mentioned above. Generally speaking, decode engine 108 may read a given macroblock from memory 110 or from buffer 118 (or from a different unit outside of memory 110) and then retrieve another macroblock that resides above the given macroblock within the frame (referred to herein as the “above-neighbor” of the given macroblock) into buffers 118. Decode engine 108 may then perform a deblocking operation with those macroblocks in order to modify the given macroblock and the above-neighbor of the given macroblock. Decode engine 108 may then update the original frame within memory 110 to include the deblocked versions of those two macroblocks. Decode engine 108 is also configured to rotate the deblocked versions of the above-neighbor macroblock and then write the rotated, deblocked above-neighbor macroblock to memory 110.

More specifically, in the example shown in FIG. 2, decode engine 108 is configured to copy macroblock 206 from frames 120 included within memory 110 to buffers 118 along path 212. Decode engine 108 may read macroblock 206 from memory 110, perform one or more processing operations with that macroblock, and then store that macroblock 206 in buffers 118 for processing by PPE 114. DMA engine 116 is also configured to copy macroblock 202 (the above-neighbor of macroblock 206) from frames 120 within memory 110 to buffers 118 along path 212. In various other embodiments, DMA engine 116 may retrieve macroblocks 202 and/or 206 from a unit configured to process those macroblocks, such as an upstream decoding unit in a pipeline of units, and DMA engine 116 may not need to read macroblocks 202 and/or 206 from memory 110.

Once macroblocks 202 and 206 are resident in buffers 118, PPE 114 may then read macroblocks 206 and at least a portion of macroblock 202 from buffers 118 in order to perform a deblocking operation. In one embodiment, PPE 114 only reads strip 210 of pixels from macroblock 202 stored within buffer 118 when performing the deblocking operation. PPE 114 performs the deblocking operation with macroblocks 202 and 204 to generate deblocked versions of macroblocks 202 and 206 that reside within buffers 118 across path 214. Those deblocked versions are shown in FIG. 2 as macroblocks 202-D and 206-D. In embodiments where PPE 114 only requires strip 210 of pixels from macroblock 202 to perform the deblocking operation with macroblock 206, PPE 114 may only perform the deblocking operation with macroblock 206 and strip 210 associated with macroblock 202 within buffer 118, thereby generating macroblock 206-D and a deblocked strip 210 of pixels.

Once the deblocking operation is complete, PPE 114 is configured to issue a first write command to DMA engine 116 that causes DMA engine 116 to update frames 120 across path 216 to reflect the deblocked versions of macroblocks and/or the deblocked portions of macroblocks stored within buffer 118. The first write command could be, e.g., a decode surface write command. PPE 114 is also configured to issue a second write command to DMA engine 116 that causes DMA engine 116 to rotate macroblock 206-D stored within buffer 118 and to write the rotated macroblock 206-D to rotated frames 122 across path 218. The second write command could be, e.g., a display surface write command. DMA engine 116 may also issue the display surface write command itself and perform the rotation operation without PPE 114 issuing a write command. In one embodiment, DMA engine 116 implements the rotation operation by transforming the address space to which macroblock 206-D is to be written to reflect a rotated version of macroblock 206-D. In this embodiment, DMA engine 116 need not explicitly rotate macroblock 206-D, DMA engine 116 simply writes macroblock 206-D according to a rotated sequence of addresses.

Decode engine 108 may implement the technique described above for each macroblock and corresponding above-neighbor macroblock within frame 200. Decode engine 108 may also implement the techniques described above for certain rows of macroblocks within frame 200 and corresponding above-neighbor rows. In such cases, decode engine 108 may buffer the entire row and above-neighbor row within buffers 118. When deblocking the bottom row of frame 200 with the above-neighbors of the macroblocks within that bottom row, decode engine 108 may also rotate the macroblocks within that bottom row. Additionally, decode engine 108 may employ the technique described above relative to entire frames of video data.

Persons skilled in the art will recognize that the technique described by way of example in conjunction with FIG. 2 may be applied to frames of video having any number of macroblocks. Further, persons skilled in the art will also recognize that the deblocking operation described above may correspond to any technically feasible deblocking operation or post-processing operation, and may thus involve any number of different macroblocks or any sized portion of frames of video data. In addition, persons skilled in the art will understand that frames 120, representing non-rotated, deblocked frames, may be used for other operations that require multiple, sequential non-rotated frames, such as, e.g., compression or decompression operations.

By performing the rotation operation in conjunction with the deblocking operation, as described herein, decode engine 108 may avoid performing redundant read operations of macroblocks that require both deblocking and rotation, as required by conventional approaches. With a conventional approach, strip 210 of pixels within macroblock 202 would be read from memory 110 in order to perform a deblocking operation, and then macroblock 202 as a whole would be subsequently read from memory 110 in order to perform a rotation operation, thereby reading strip 210 of pixels from memory 110 twice. However, with the approach describe herein, decode engine 108 is only required to read those pixels once, thereby reducing the bandwidth required to perform the rotation operation.

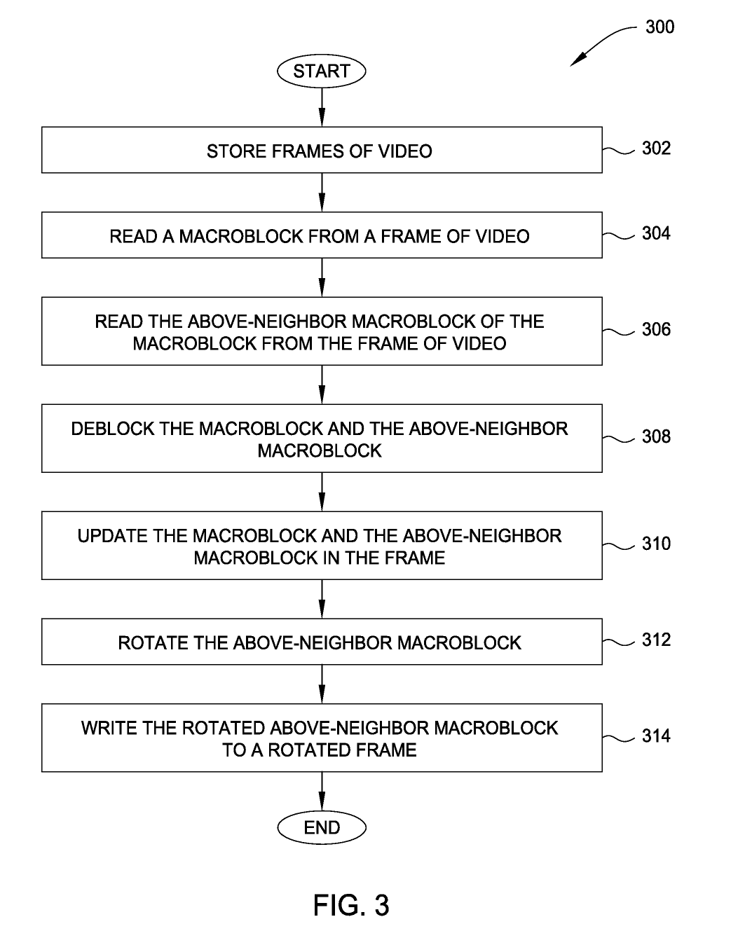

The techniques described thus far are also described in greater detail below in conjunction with FIG. 3.

FIG. 3 illustrates a flow diagram of method steps for rotating a frame of video to generate a rotated frame of video, according to one embodiment of the present invention. Although the method steps are described in conjunction with the systems of FIGS. 1-2, persons skilled in the art will understand that any system configured to perform the method steps, in any order, is within the scope of the present invention.

As shown, a method 300 begins at step 302, where memory 110 stores frames 120 of video data captured by a video camera within I/O devices 106. Frame 120 of video data could also be derived from a DVD, BluRay, Disc, or another source of frames of video data and then stored in memory 110. The frames of video data could also be stored elsewhere or buffered by a unit within a processing pipeline. At step 304, PPE 114 within decode engine 108 reads a macroblock associated with a frame of video included within frames 120. The macroblock may be stored in a buffer accessible to PPE 114, such as buffers 118, or provided to PPE 114 by a processing pipeline implemented by decode engine 108. The frame of video could be, e.g. frame 200 of video shown in FIG. 2, and the macroblock could be, e.g. macroblock 206 included within frame 200.

At step 306, DMA engine 116 reads the above-neighbor of the macroblock previously read at step 304. The above-neighbor macroblock could be, e.g., macroblock 202 shown in FIG. 2. DMA engine 116 is configured to temporarily store the macroblock and the above-neighbor macroblock in buffers 118. DMA engine 116 may also retrieve the above-neighbor macroblock from a unit outside of memory 110. That unit could be configured to perform other processing operations with macroblocks, such as e.g. decoding operations, among others.

At step 308, PPE 114 within decode engine 108 performs a deblocking operation with the macroblock read at step 304 and the above-neighbor macroblock read at step 306. PPE 114 may also perform the deblocking operation with the macroblock and just a portion of the above-neighbor macroblock, such as, e.g., strip 210 of pixels included within macroblock 202. Upon performing the deblocking operation, PPE 114 may update the macroblock and above-neighbor macroblock within buffers 118 to reflect the results of the deblocking operation.

At step 310, DMA engine 116 updates the macroblock and the above-neighbor macroblock within frame 120 in memory 110. In doing so, DMA engine 116 may receive a decode surface write command from PPE 116 and, in response, write the deblocked macroblock and deblocked above-neighbor macroblock to frames 120. DMA engine 116 may also issue the decode surface write command itself and perform the associated write of deblocked macroblock and deblocked above-neighbor macroblock to frames 120.

At step 312, DMA engine 116 rotates the above-neighbor macroblock previously deblocked at step 308 and resident within buffers 118. At step 314, DMA engine 116 writes the rotated, deblocked above-neighbor macroblock to rotated frames 122 within memory 110. In performing steps 312 and 314, DMA engine 116 may receive a display surface write command from PPE 114 and, in response, rotate the deblocked above-neighbor macroblock and then write the rotated, deblocked above-neighbor macroblock to rotated frames 122. The method 300 then ends.

In sum, a decode engine is configured to perform a rotation operation with a macroblock in conjunction with performing a deblocking operation that involves the macroblock. The decode engine buffers the macroblock and performs the deblocking operation to generate a deblocked macroblock, then rotates the deblocked macroblock and writes the rotated, deblocked macroblock to memory. With this approach, multiple, redundant reads of the macroblock, as required with conventional rotation techniques, may be avoided.

Advantageously, the amount of data read from memory in order to rotate frames of video data is reduced, thereby decreasing the amount of memory bandwidth and power consumed when rotating those frames. In addition, the latency penalty typically incurred by conventional approaches to rotating video frames may be reduced, thereby improving the user experience of viewing video.

While the foregoing is directed to embodiments of the present invention, other and further embodiments of the invention may be devised without departing from the basic scope thereof. For example, aspects of the present invention may be implemented in hardware or software or in a combination of hardware and software. One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons of ordinary skill in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Therefore, the scope of the present invention is determined by the claims that follow.

The invention claimed is:

1. A computer-implemented method for processing frames of video data, the method comprising:
retrieving from a local buffer a first portion of video data that is associated with a first frame included in a plurality of frames of video data;
copying to the local buffer a second portion of video data that is also associated with the first frame, wherein the second portion of video data resides adjacent to the first portion of video data within the first frame;
performing a deblocking operation based on the first portion of video data and the second portion of video data to generate a deblocked first portion of video data and a deblocked second portion of video data;
performing a rotation operation on the deblocked second portion of video data to generate a rotated and deblocked second portion of video data; and
writing the rotated and deblocked second portion of video data to a memory unit.

2. The computer-implemented method of claim 1, further comprising storing the deblocked first portion of video data and the deblocked second portion of video data in the local buffer.

3. The computer-implemented method of claim 2, further comprising copying the deblocked first portion of video data and the deblocked second portion of video data from the local buffer to the first frame in the memory unit.

4. The computer-implemented method of claim 3, wherein copying the deblocked first portion of video data and the deblocked second portion of video data from the local buffer to the first frame comprises causing a post-processing engine (PPE) to issue a decode surface write command to a direct memory access (DMA) engine coupled to the local buffer.

5. The computer-implemented method of claim 2, wherein performing the rotation operation comprises:
causing a direct memory access (DMA) engine to read the deblocked second portion of video data from the local buffer; and
causing the DMA engine to determine a rotated address space to which the deblocked second portion of video data should be written in the memory unit.

6. The computer-implemented method of claim 5, wherein writing the rotated and deblocked second portion of video data to the memory unit comprises causing a post-processing engine (PPE) to issue a display surface write command to the DMA engine to cause the DMA engine to write the rotated and deblocked second portion of video data to the memory unit.

7. The computer-implemented method of claim 1, wherein the first portion of video data comprises a first macroblock associated with the first frame, the second portion of video data comprises a second macroblock associated with the first frame, and the second macroblock comprises the above-neighbor of the first macroblock within the first frame.

8. The computer-implemented method of claim 1, wherein the rotation operation comprises a transposition operation.

9. A non-transitory computer-readable medium storing program instructions that, when executed by a processing unit, cause the processing unit to process frames of video data by performing the steps of:
retrieving from a local buffer a first portion of video data that is associated with a first frame included in a plurality of frames of video data;
copying to the local buffer a second portion of video data that is also associated with the first frame, wherein the second portion of video data resides adjacent to the first portion of video data within the first frame;
performing a deblocking operation based on the first portion of video data and the second portion of video data to generate a deblocked first portion of video data and a deblocked second portion of video data;
performing a rotation operation on the deblocked second portion of video data to generate a rotated and deblocked second portion of video data; and
writing the rotated and deblocked second portion of video data to a memory unit.

10. The non-transitory computer-readable medium of claim 9, further comprising the step of storing the deblocked first portion of video data and the deblocked second portion of video data in the local buffer.

11. The non-transitory computer-readable medium of claim 10, further comprising the step of copying the deblocked first portion of video data and the deblocked second portion of video data from the local buffer to the first frame in the memory unit.

12. The non-transitory computer-readable medium of claim 11, wherein the step of copying the deblocked first portion of video data and the deblocked second portion of video data from the local buffer to the first frame comprises causing a post-processing engine (PPE) to issue a decode surface write command to a direct memory access (DMA) engine coupled to the local buffer.

13. The non-transitory computer-readable medium of claim 10, wherein the step of performing the rotation operation comprises:
causing a direct memory access (DMA) engine to read the deblocked second portion of video data from the local buffer; and
causing the DMA engine to determine a rotated address space to which the deblocked second portion of video data should be written in the memory unit.

14. The non-transitory computer-readable medium of claim 13, wherein the step of writing the rotated and deblocked second portion of video data to the memory unit comprises causing a post-processing engine (PPE) to issue a display surface write command to the DMA engine to cause the DMA engine to write the rotated and deblocked second portion of video data to the memory unit.

15. The non-transitory computer-readable medium of claim 9, wherein the first portion of video data comprises a first macroblock associated with the first frame, the second portion of video data comprises a second macroblock associated with the first frame, and the second macroblock comprises the above-neighbor of the first macroblock within the first frame.

16. The non-transitory computer-readable medium of claim 9, wherein the rotation operation comprises a transposition operation.

17. A system for processing video data, including:
a processing unit configured to:
retrieve from a local buffer a first portion of video data that is associated with a first frame included in a plurality of frames of video data;
copy to the local buffer a second portion of video data that is also associated with the first frame, wherein the second portion of video data resides adjacent to the first portion of video data within the first frame,
perform a deblocking operation based on the first portion of video data and the second portion of video data to generate a deblocked first portion of video data and a deblocked second portion of video data,
perform a rotation operation on the deblocked second portion of video data to generate a rotated and deblocked second portion of video data, and
write the rotated and deblocked second portion of video data to a memory unit.

18. The system of claim 17, further including:
a memory coupled to the processing unit and storing program instructions that, when executed by the processing unit, cause the processing unit to:
retrieve from the local buffer the first portion of the video data;
copy to the local buffer the second portion of the video;
perform the deblocking operation;
perform the rotation operation; and
write the rotated and deblocked second portion of video data to the memory unit.

19. The computer system of claim 17, wherein performing the rotation operation comprises:
causing a direct memory access (DMA) engine to read the deblocked second portion of video data from the local buffer; and
causing the DMA engine to determine a rotated address space to which the deblocked second portion of video data should be written in the memory unit.

20. The computer system of claim 17, wherein the first portion of video data comprises a first macroblock associated with the first frame, the second portion of video data comprises a second macroblock associated with the first frame, and the second macroblock comprises the above-neighbor of the first macroblock within the first frame.
